(19) United States
(12) Patent Application Publication
(10) Pub. No.: US 2008/0218700 A1
(43) Pub. Date: Sep. 11, 2008

(54) BAR-TYPE DISPLAY DEVICE USING DIFFRACTIVE LIGHT MODULATOR

(75) Inventors: Haeng Seok Yang, Bucheon-si (KR); Sung Kyong Oh, Suwon (KR); Sang Kyeong Yun, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/039,625

(22) Filed: Feb. 28, 2008

(30) Foreign Application Priority Data
Mar. 8, 2007 (KR) 10-2007-0023100

(51) Int. Cl. G03B 21/14

(52) U.S. Cl. 353/81; 353/122

(57) ABSTRACT

Disclosed herein is a display device using a diffractive light modulator. The display device includes a light source unit, a light condensing unit, an illumination unit, a diffractive light modulator, a light path adjustment unit, and a projection unit. The light path adjustment unit causes the linear light to enter the diffractive light modulator, and emits the diffracted light along a line extending from an incident light path.

### CROSS REFERENCE TO RELATED APPLICATION

This application claims the benefit of Korean Patent Application No. 10-2007-0023100, filed on Mar. 8, 2007, entitled “Bar Type Display Apparatus using the Diffractive Optical Modulator,” which is hereby incorporated by reference in its entirety into this application.

### BACKGROUND OF THE INVENTION

1. Field of the Invention

The present invention relates generally to a display device using a diffractive light modulator and, more particularly, to a bar-type small-sized display device using a diffractive light modulator, which is fabricated in a bar form, and thus can be applied to a mobile terminal.

2. Description of the Related Art

Of display devices, small-sized display devices are display devices that have small sizes and low power consumption. Such small-sized display devices are used particularly as the displays of mobile terminals.

Devices that are particularly effective at generating images in such small-sized display devices are Spatial Light Modulators (SLMs). SLMs are devices that display images by modulating incident light. Incident light can be modulated in phase, intensity, polarization or direction by an SLM.

Of SLMs, a diffractive light modulator is a device for generating diffracted light by modulating incident light and creating images using the generated diffracted light. An example of a display device using a diffractive light modulator is shown in FIG. 1.

FIG. 1 is a diagram showing the construction of a display device using a prior art box-type diffractive light modulator.

Referring to this drawing, the display device using the prior art box-type diffractive light modulator includes a light source unit 10, a light condensing unit 12, an illumination unit 14, a diffractive light modulator 18, a projection unit 20, and a screen 26.

In this case, the light source unit 10 includes a plurality of light sources 11a˜11c. In an application, the light sources 11a˜11c may be configured to sequentially emit light. Meanwhile, the light condensing unit 12 includes a single 13a and a plurality of dichroic mirrors 13b and 13c, and causes light beams, emitted from the plurality of light sources 11a˜11c, to have the same path.

The illumination unit 14 converts light, having passed through the light condensing unit 12, into linear parallel light, and causes the linear parallel light to enter the diffractive light modulator 18. Meanwhile, the diffractive light modulator 18 generates linear diffracted light having a plurality of diffraction orders by modulating the incident linear parallel light, in which case the light intensity of diffracted light, having one or more diffraction orders necessary for a specific application, may vary at respective points of the path of the diffracted light, so that the diffracted light can form images on the screen 26. That is, since the diffracted light generated by the diffractive light modulator 18 is linear and the linear diffracted light may have different light intensities at respective points, the diffracted light may form a two-dimensional image when it is scanned across the screen 26.

Meanwhile, the diffracted light generated by the diffractive light modulator 18 enters the projection unit 20. The projection unit 20 includes a projection lens 21, a Fourier lens 22, a Fourier filter 23, and a scanner 24.

This projection lens 21 focuses the diffracted light on the screen 26, and the Fourier lens 22 separates the diffracted light according to the diffraction order.

The Fourier filter 23 passes only diffracted light having one or more desired diffraction orders, which belongs to the separated diffracted light, therethrough.

The scanner 24 performs lateral scanning, and forms images on the screen 26.

That is, the projection unit 20 separates the diffracted light according to diffraction order, passes only diffracted light having one or more desired diffraction orders, which belongs to the separated diffracted light, therethrough, and forms images by projecting the diffracted light having the one or more desired diffraction orders onto the screen 26.

Meanwhile, since the above-described display device using a diffractive light modulator is a box type, it has limited applications.

Furthermore, the prior art display device using a diffractive light modulator has a problem in that it is difficult to adjust upon assembly because the path of light must be bent a plurality of times in order to fabricate the box-type display device.

Furthermore, the prior art display device using a diffractive light modulator has a problem in that the width of the mirrors used in the scanner of the projection unit is large because respective lenses should be spaced apart from a predetermined distance due to limitation related to the distance required between the illumination unit and the projection unit.

Furthermore, the prior art display device using a diffractive light modulator has a problem in that it is difficult to apply the prior art display device to mobile terminals in light of the fact that users demand small-sized mobile terminals.

### SUMMARY OF THE INVENTION

Accordingly, the present invention has been made keeping in mind the above problems occurring in the prior art, and an object of the present invention is to provide a display device using a diffractive light modulator, in which an illumination lens or a projection lens is formed of a prism reflection lens or a mirror reflection lens, thereby realizing a reduction in the size of the display device.

Furthermore, another object of the present invention is to provide a display device using a diffractive light modulator, in which an illumination lens and a projection lens are integrated in the diffractive light modulator, and thus no change in light path is required during a specific interval, thereby being easy to adjust upon assembly.

Furthermore, still another object of the present invention is to provide a display device using a diffractive light modulator, in which an illumination lens or a projection lens is formed of a prism reflection lens or a mirror reflection lens, and thus an abrupt change in light path is made possible, thereby providing excellent adaptability to various applications.

Furthermore, a further object of the present invention is to provide a display device using a diffractive light modulator, in which the distance between an illumination lens and a projection lens is not limited, and thus the numerical aperture can be decreased and the width of a scanner mirror can be reduced, thereby overcoming limitation related to the size of a scanner.

In order to accomplish the above object, the present invention provides a display device using a diffractive light modulator, including a light source unit for generating and emitting a plurality of beams of light; a light condensing unit for causing the plurality of beams of light, emitted from the light source unit, to have the same light path; an illumination unit for converting the light, emitted from the light source unit, into linear light; a diffractive light modulator for generating diffracted light having a plurality of diffraction orders so that diffracted light having one or more diffraction orders required for an application has a light intensity appropriate for the application at each point by modulating linear incident light, and emitting the diffracted light; a light path adjustment unit for causing the linear light, emitted from the illumination unit, to enter the diffractive light modulator, and emitting the diffracted light, emitted from the diffractive light modulator, along a line extending from an incident light path; and a projection unit for forming images by projecting the diffracted light, emitted from the diffractive light modulator, onto a screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a prior art box-type display device using a diffractive light modulator;

FIG. 2 is a diagram showing the construction of a bar-type display device using a diffractive light modulator according to an embodiment of the present invention;

FIG. 3 is an enlarged sectional view showing the diffraction unit of FIG. 2;

FIG. 4 is an enlarged view showing the lens of FIG. 3; and

FIG. 5 is a diagram showing the construction of a bar-type display device using a diffractive light modulator according to another embodiment of the present invention.

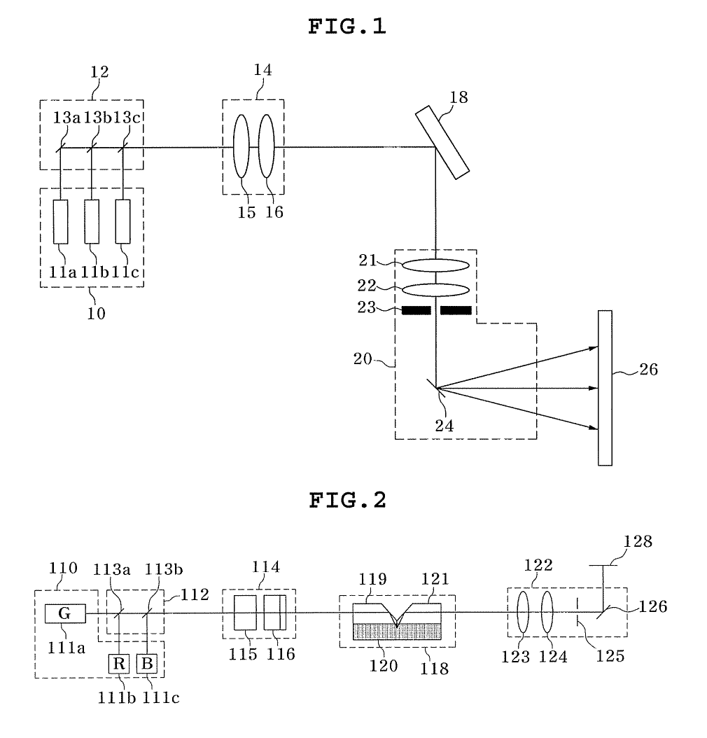

### DESCRIPTION OF THE PREFERRED EMBODIMENTS

Reference now should be made to the drawings, in which the same reference numerals are used throughout the different drawings to designate the same or similar components.

With reference to FIGS. 2 to 5, a bar-type display device using a diffractive light modulator according to the present invention will be described in detail below.

FIG. 2 is a diagram showing the construction of a bar-type display device using a diffractive light modulator according to an embodiment of the present invention.

Referring to this drawing, the bar-type display device using a diffractive light modulator according to the embodiment of the present invention includes a light source unit 110 for generating and emitting a plurality of beams of light, a light condensing unit 112 for unifying the paths of the light beams emitted from the light source unit 110, an illumination unit 114 for converting light, emitted from the light condensing unit 112, into linear parallel light and causing the linear parallel light to enter a diffraction unit 118, the diffraction unit 118 for generating diffracted light having a plurality of diffraction orders by diffracting the light emitted from the illumination unit 114, and a projection unit 122 for passing diffracted light having one or more desired diffraction orders, which belongs to diffracted light having a plurality of diffraction orders emitted from the diffraction unit 118, and forming images by scanning the diffracted light having one or more desired diffraction orders across the screen 128.

The light source unit 110 includes a plurality of light sources, for example, a green light source 111a, a red light source 111b, and a blue light source 111c. In this case, the present invention uses only a single diffractive light modulator 120, in which case the light source unit 110 emits green light, red light, and blue light in a time division manner.

In this case, since a solid semiconductor laser is used as the green light source 111a of the light source unit 110, the size thereof is large, so that space can be effectively used if the light emitting surface thereof is disposed perpendicular to a relevant light axis. In contrast, since the red light source 111b and the blue light source 111c are smaller than the green light source 111a, a reduction in size can be accomplished, even though they are implemented such that the light emitting surfaces thereof are disposed parallel to a relevant light axis.

Since, in the case of the green light source 111a, the light emitting surface thereof is perpendicular to a relevant light axis and light emitted therefrom is parallel to the relevant light axis as described above, the light condensing unit 112 does not require separate means for changing the light path of emitted light.

In contrast, since, in the case of the red light source 111b and the blue light source 111c, the light emitting surfaces thereof are parallel to a relevant light axis, emitted light is perpendicular to the light axis, so that the light condensing unit 112 requires separate means for changing the relevant light path so that it is parallel to the light axis.

The light condensing unit 112 includes two dichroic mirrors 113a and 113b that correspond to respective light sources 111b and 111c.

The first dichroic mirror 113a passes light, emitted from the green light source 110a, therethrough along the light axis, and reflects light, emitted from the red light source 111b, parallel to the light axis.

The second dichroic mirror 113b passes the green light, emitted from the first dichroic mirror 113a, and the red light therethrough, and reflects light, emitted from the blue light source 110c, parallel to the light axis.

Meanwhile, the illumination unit 114 includes a first cylinder lens 115 having a curved surface in the Y-axis direction (the Y axis is indicated in the drawing) and a second cylinder lens 116 having a curved surface in the X-axis direction (the X axis is indicated in the drawing).

That is, the illumination unit 114 expands the light, emitted from the light source unit 110, in the Y-axis direction relative to the light path direction (which is indicated as the Z-axis direction in the drawing), converts the expanded light into parallel light, converts the parallel light into linear light by condensing the parallel light in the X-axis direction, and causes the linear light to enter the diffraction unit 118.

Meanwhile, the diffraction unit 118 includes a light path changing illumination lens 119, a diffractive light modulator 120, and a light path changing projection lens 121.

The light path changing illumination lens 119 changes the light path by causing incident light, emitted from the illumination unit 114, to enter the diffractive light modulator 120 perpendicular thereto.

The diffractive light modulator 120 generates diffracted light having a plurality of diffraction orders, the light intensity of which has been adjusted, by diffracting the linear light incident from the illumination unit 114 and the light path changing illumination lens 119.

In this case, the diffracted light emitted from the diffractive light modulator 120 includes diffracted light having various diffraction orders, such as 0th-order diffracted light, 1st-order diffracted light, 2nd-order diffracted light, and 3rd-order diffracted light.

Meanwhile, the diffracted light emitted from the diffractive light modulator 120 is diffracted light that has a linear shape, a long length and a narrow width (hereinafter referred to as a “line image”).

In this case, the diffractive light modulator 120 includes, for example, a plurality of upper reflective portions configured to be movable vertically and configured to form an array, and a plurality of lower reflective portions disposed between the upper reflective portions and spaced apart from the upper reflective portions by a predetermined distance. The diffractive light modulator 120 may use electrostatic force or magnetostatic force as means for driving the upper reflective portions. Alternatively, the diffractive light modulator 120 may use a piezoelectric material layer on one surface of which an upper electrode layer is formed and on another surface of which a lower electrode layer is formed.

With regard to the diffracted light emitted from the diffractive light modulator 120, diffracted light generated by a single upper reflective portion and a corresponding lower reflective portion may form diffracted light that corresponds to a single pixel formed on the screen 128, and diffracted light generated by two or more upper reflective portions and corresponding lower reflective portions may form diffracted light that corresponds to a single pixel formed on the screen 128.

Thereafter, the light path changing projection lens 121 changes the light path of diffracted light, emitted from the diffractive light modulator 120, into a direction parallel to the light axis because the light path of the diffracted light, emitted from the diffractive light modulator 120, is almost perpendicular to the light axis, and emits the diffracted light, the light path of which has been changed, toward the screen 128.

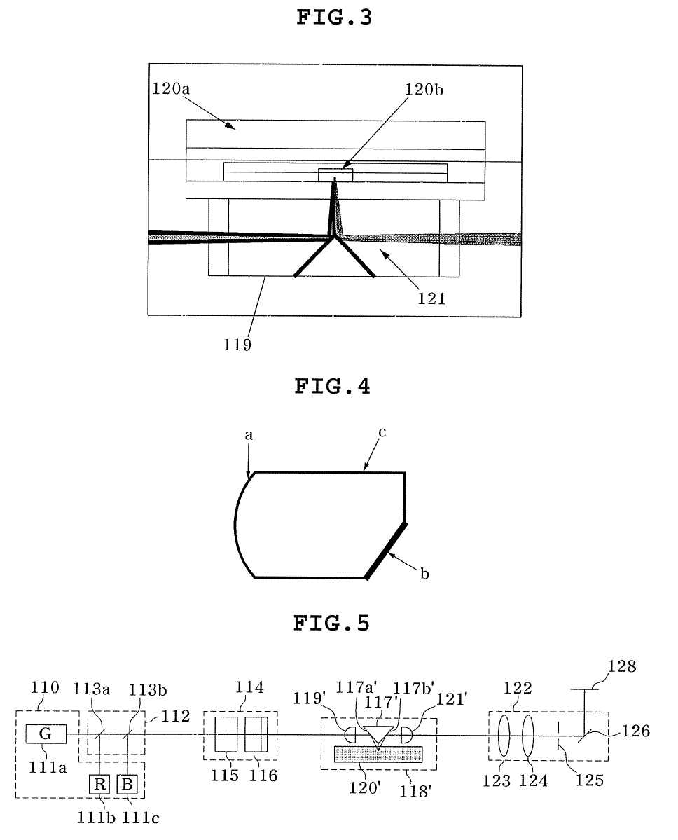

An enlarged sectional view of the diffraction unit 118 is shown in FIG. 3. Referring to FIG. 3, the diffractive light modulator 120 includes a diffractive light modulator module 120a and a diffractive light modulator chip 120b, and the light path changing illumination lens 119 changes the light path so as to direct the illumination light toward the diffractive light modulator chip 120b. Furthermore, the light path changing projection lens 121 changes the light path so that diffracted light, emitted from the diffractive light modulator chip 120b, is parallel to the light axis.

An embodiment of each of the light path changing illumination lens 119 and the light path changing projection lens 121 is shown in FIG. 4, and has a prism reflection mirror shape. That is, each of the lenses 119 and 121 has a concave ellipse-shaped lens curvature surface ‘a,’ through which incident light enters. Furthermore, each of the lenses 119 and 121 has a reflective mirror surface ‘b,’ which is disposed opposite the lens curvature surface ‘a,’ which is inclined at a predetermined angle, and which changes the light path of light, passed through the lens curvature surface ‘a,’ toward the diffractive light modulator chip 120b. Furthermore, each of the lenses 119 and 121 has a transmissive surface ‘c,’ through which light reflected on the flat reflective mirror surface b passes, which allows the reflected light to reach the diffractive light modulator chip 120b, and which has a flat surface.

The transmissive surfaces c of the light path changing illumination lens 119 and the light path changing projection lens 121 are flat and are attached to the diffractive light modulator module 120a. In this manner, the lenses 119 and 121 and the diffractive light modulator 120 are integrated into a single body.

In this case, the light path changing illumination lens 119 and the light path changing projection lens 121 may be collectively considered to be a light path adjustment unit that causes linear light, emitted from the illumination unit 114, to enter the diffractive light modulator 120, and emits the diffracted light, emitted from the diffractive light modulator 120, along a line extending from the incident light path.

The projection unit 122 scans the diffracted light having a plurality of diffraction orders, emitted from the diffractive light modulator 120, across the screen 128. In this case, the projection unit 122 includes a projection lens 123 for condensing the diffracted light emitted from the diffractive light modulator 120, a Fourier lens 124 for separating the diffracted light according to diffraction order, a Fourier filter 125 for passing diffracted light having one or more diffraction orders, which belongs to the diffracted light passed through the Fourier lens 124, therethrough, and a scanner 126 for scanning the diffracted light across the screen 128. Here, the projection lens 123, the Fourier lens 124, the Fourier filter 125, and the scanner 126 are disposed parallel to the light axis.

The projection lens 123 condenses the diffracted light so that the diffracted light, emitted from the diffractive light modulator 120, is focused on the screen 128.

The Fourier lens 124 receives the diffracted light having a plurality of diffraction orders in the state in which the minimum distance between diffracted light having respective diffraction orders has not been sufficiently ensured, and emits the diffracted light having a plurality of diffraction orders in the state in which the minimum distance between the diffracted light having respective diffraction orders has been sufficiently ensured.

The Fourier filter 125 passes diffracted light having one or more desired diffraction orders, which belongs to the diffracted light having a plurality of diffraction orders passed through the Fourier lens 124, therethrough.

And the Fourier filter 125 is disposed nearby Fourier Plane of the projection lens 123 between the projection lens 123 and the scanner 126 and passes diffracted light having one or more desired diffraction orders, which belongs to the diffracted light having a plurality of diffraction orders emitted from the scanner 126, therethrough.

Here, the filter 125 is also disposed between the diffractive light modulator 120 and the scanner 126, and passes diffracted light having one or more desired diffraction orders, which belongs to the diffracted light having a plurality of diffraction orders emitted from the diffractive light modulator 120, therethrough.

The scanner 126 of the projection unit 122 generates two-dimensional images by scanning the linear diffracted light, expanded through the projection lens 123, across the screen 128.

Here, a Galvanometer mirror or a polygon mirror may be used as the scanner 126.

A Galvano scanner has a square plate shape, and is provided with a mirror that is attached to one surface of the Galvano scanner. The Galvano scanner laterally rotates within a predetermined angular range around an axis. The polygon mirror scanner has a polygonal column shape, and is provided with mirrors that are attached to the side surfaces of the polygonal column. The polygonal mirror scanner projects images on the screen 128 by varying the reflection angle of incident light using the mirrors attached to the sides thereof while rotating in one direction around an axis.

FIG. 5 is a diagram showing the construction of a bar-type display device using a diffractive light modulator according to another embodiment of the present invention.

Referring to this drawing, the bar-type display device using a diffractive light modulator according to another embodiment of the present invention is the same as that of FIG. 2 except for a diffraction unit 118′.

The diffraction unit 118′ includes an illumination lens 119′, a path changing prism 117′, a diffractive light modulator 120′, and a projection lens 121′.

The illumination lens 119′ causes incident light, emitted from the illumination unit 114, to enter the light incident surface 117a′ of the path changing prism 117′.

The path changing prism 117′ changes the light path so that the incident light, emitted from the illumination lens 119′, enters the diffractive light modulator 120′ almost in a vertical direction.

The diffractive light modulator 120′ generates diffracted light having a plurality of diffraction orders, the light intensity of which has been adjusted, by diffracting linear light incident through the illumination unit 114 and the illumination lens 119′, and emits the diffracted light toward the light emitting surface 117b′ of the path changing prism 117′.

Then, the light emitting surface 117b′ of the path changing prism 117′ directs the diffracted light, emitted from the diffractive light modulator 120′, toward the projection lens 121′.

The projection lens 121′ directs diffracted light, emitted from the path changing prism 117′, toward the projection unit 122.

In this case, the illumination lens 119′, the projection lens 121′ and the path changing prism 117′ may be collectively considered to be a light path adjustment unit that causes linear light, emitted from the illumination unit 114, to enter the diffractive light modulator 120 and emits the diffracted light, emitted from the diffractive light modulator 120, along a line extending from the incident light path.

According to the present invention, an illumination lens or a projection lens is formed of a prism reflection lens or a mirror reflection lens, thereby realizing a reduction in the size of the display device.

Furthermore, according to the present invention, an illumination lens and a projection lens are integrated in a diffractive light modulator, and thus no change in light path is required during a specific interval, thereby being easy to adjust upon assembly.

Furthermore, according to the present invention, an illumination lens or a projection lens is formed of a prism reflection lens or a mirror reflection lens, and thus an abrupt change in light path is made possible, thereby providing excellent adaptability to various applications.

Furthermore, according to the present invention, the distance between the illumination lens and the projection lens is not limited, and thus the numerical aperture can be decreased and the width of a scanner mirror can be reduced, thereby overcoming limitation related to the size of a scanner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A display device using a diffractive light modulator, comprising:
a light source unit for generating and emitting a plurality of beams of light;
a light condensing unit for causing the plurality of beams of light, emitted from the light source unit, to have a same light path;
an illumination unit for converting the light, emitted from the light source unit, into linear light;
a diffractive light modulator for generating diffracted light having a plurality of diffraction orders so that diffracted light having one or more diffraction orders required for an application has a light intensity appropriate for the application at each point by modulating linear incident light, and emitting the diffracted light;
a light path adjustment unit for causing the linear light, emitted from the illumination unit, to enter the diffractive light modulator, and emitting the diffracted light, emitted from the diffractive light modulator, along a line extending from an incident light path; and
a projection unit for forming images by projecting the diffracted light, emitted from the diffractive light modulator, onto a screen.

2. The display device as set forth in claim 1, wherein the light path adjustment unit comprises:
a light path changing illumination lens comprising a first reflective surface that is located opposite the illumination unit and changes a light path of the light, emitted from the illumination unit, so as to cause the light incident from the illumination unit to enter the diffractive light modulator; and
a light path changing projection lens comprising a second reflective surface that is located opposite the projection unit and reflects the diffracted light, emitted from the diffractive light modulator, so as to cause the diffracted light to propagate along a line extending from a light path of the light incident from the illumination unit.

3. The display device as set forth in claim 1, wherein the light path adjustment unit comprises a path changing prism that causes the linear light, emitted from the illumination unit, to enter the diffractive light modulator and changes a light path of the diffracted light, emitted from the diffractive light modulator, so as to cause the diffracted light to propagate along a line extending from a light path of the diffracted light, emitted from the illumination unit.

4. The display device as set forth in claim 3, wherein the light path adjustment unit further comprises:
an illumination lens for causing the linear light, emitted from the illumination unit, to enter one surface of the path changing prism; and
a projection lens for causing the diffracted light, emitted from the path changing prism, to enter the projection unit.

5. The display device as set forth in claim 1, wherein the projection unit comprises:
a projection lens for expanding the diffracted light having a plurality of diffraction orders emitted from the diffractive light modulator; and
a scanner for scanning the diffracted light, emitted from the projection lens, across the screen.

6. The display device as set forth in claim 5, wherein the projection unit comprises a filter that is disposed nearby Fourier Plane of the projection lens between the projection lens and the scanner and passes diffracted light having one or more desired diffraction orders, which belongs to the diffracted light having a plurality of diffraction orders emitted from the scanner, therethrough.

7. The display device as set forth in claim 1, wherein the projection unit comprises a filter that is disposed between the diffractive light modulator and the scanner, and passes diffracted light having one or more desired diffraction orders, which belongs to the diffracted light having a plurality of diffraction orders emitted from the diffractive light modulator, therethrough.
